(19) United States
(12) Patent Application Publication
(10) Pub. No.: US 2026/0158870 A1
(43) Pub. Date: Jun. 11, 2026

(54) HEAT PUMP SYSTEM FOR A VEHICLE

(71) Applicants: HYUNDAI MOTOR COMPANY, Seoul (KR); KIA CORPORATION, Seoul (KR)

(72) Inventors: Yeon Ho Kim, Hwaseong-si (KR); Hochan An, Hwaseong-si (KR); Jeawan Kim, Hwaseong-si (KR); Hoyoung Jeong, Hwaseong-si (KR); Man Hee Park, Hwaseong-si (KR); Yeong Jun Kim, Hwaseong-si (KR); Jae Yeon Kim, Hwaseong-si (KR); Gwi Taek Kim, Hwaseong-si (KR)

(73) Assignees: HYUNDAI MOTOR COMPANY, Seoul (KR); KIA CORPORATION, Seoul (KR)

(21) Appl. No.: 19/227,794

(22) Filed: Jun. 4, 2025

(30) Foreign Application Priority Data
Dec. 6, 2024 (KR) 10-2024-0181013

(51) Int. Cl. B60H 1/32; B60H 1/00; F25B 30/02; F25B 41/31; F25B 43/00

(52) U.S. Cl. CPC B60H 1/3228; B60H 1/00278; B60H 1/00335; B60H 1/00485; F25B 30/02; F25B 41/31; F25B 43/006

(57) ABSTRACT

A heat pump system for a vehicle is provided to improve cooling and heating performance by applying a gas injection device selectively operating in an air conditioning mode of vehicle interior to increase the flow rate of the refrigerant. The heat pump system includes a compressor, an HVAC module, an external heat-exchanger, a first expansion valve, an accumulator, a first connection line, a chiller, a second expansion valve, a gas injection device, and a second connection line, where a flow direction of the refrigerant is controlled depending on at least one mode for a temperature control of a vehicle interior.

### CROSS-REFERENCE TO RELATED APPLICATION

This application claims priority to and the benefit of Korean Patent Application No. 10-2024-0181013 filed with the Korean Intellectual Property Office on Dec. 6, 2024, the entire contents of which is incorporated herein by reference.

### BACKGROUND

### Technical Field

The present disclosure relates to a heat pump system for a vehicle, and more particularly, the present disclosure relates to a heat pump system for a vehicle capable of improving the cooling and heating performance by employing a gas injection device configured to selectively operate in a selected air conditioning mode.

### Description of the Related Art

Generally, an air conditioning system for a vehicle includes an air conditioner unit circulating a refrigerant in order to heat or cool an interior of a vehicle.

The air conditioner unit, which maintains the interior of the vehicle at an appropriate temperature regardless of a change in an external temperature to maintain a comfortable interior environment, is configured to heat or cool the interior of the vehicle by heat-exchange by a condenser and an evaporator in a process in which a refrigerant discharged by the driving of a compressor is circulated back to the compressor through the condenser, a receiver drier, an expansion valve, and the evaporator.

In other words, the air conditioner unit lowers a temperature and a humidity of the interior by condensing a high-temperature high-pressure gas-phase refrigerant compressed from the compressor by the condenser, passing the refrigerant through the receiver drier and the expansion valve, and then evaporating the refrigerant in the evaporator in a cooling mode in the summer.

In accordance with a continuous increase in interest in energy efficiency and an environmental pollution problem, the development of an environmentally-friendly vehicle capable of substantially substituting for an internal combustion engine vehicle is required, and the environmentally-friendly vehicle is classified into an electric vehicle driven using a fuel cell or electricity as a power source and a hybrid vehicle driven using an engine and a battery.

In an electric vehicle or a hybrid vehicle among these environmentally-friendly vehicles, a separate heater is not used unlike an air conditioner of a general vehicle, and an air conditioner used in an environmentally-friendly vehicle is called a heat pump system.

An electric vehicle driven by the power source of the fuel cell generates driving force by converting the chemical reaction energy between oxygen and hydrogen into electrical energy. In this process, heat energy is generated by a chemical reaction in a fuel cell. Therefore, it is necessary in securing performance of the fuel cell to effectively remove generated heat.

In addition, a hybrid vehicle generates driving force by driving a motor using electricity supplied from the fuel cell described above or an electrical battery, together with an engine operated by a general fuel, such as gasoline. Therefore, heat generated from the fuel cell or the battery and the motor should be effectively removed in order to secure performance of the motor.

Therefore, in a hybrid vehicle or an electric vehicle according to the related art, a cooling means, a heat pump system, and a battery cooling system, respectively, should be configured as separate closed circuits so as to prevent heat generation of the motor, an electric component, and the battery including a fuel cell.

Therefore, a size and a weight of a cooling module disposed at the front of the vehicle are increased, and a layout of connection pipes supplying a refrigerant and a coolant to each of the heat pump system, the cooling means, and the battery cooling system in an engine compartment becomes complicated.

In addition, since a battery cooling system for heating or cooling the battery according to a state of the vehicle is separately provided to obtain an optimal performance of the battery, a plurality of valves for selectively interconnecting connections pipes are employed, and thus noise and vibration due to frequent opening and closing operations of the valves may be introduced into the vehicle interior, thereby deteriorating the ride comfort of the vehicle.

In addition, for heating the vehicle interior, the heating performance may be deteriorated due to the lack of a heat source, the electricity consumption may be increased due to the usage of the electric heater, and the power consumption of the compressor may be increased.

The above information disclosed in this Background section is only for enhancement of understanding of the background of the disclosure, and therefore it may contain information that does not form the prior art that is already known in this country to those having ordinary skill in the art.

### SUMMARY

The present disclosure provides a heat pump system for a vehicle capable of improving cooling and heating performance by applying a gas injection device selectively operating in an air conditioning mode of vehicle interior to increase the flow rate of the refrigerant.

A heat pump system for a vehicle includes a compressor configured to compress a refrigerant. The heat pump system further includes an HVAC module in which an internal condenser and an evaporator connected to the compressor through a refrigerant line are provided. The heat pump system further includes an external heat-exchanger connected to the internal condenser through the refrigerant line, and configured to condense or evaporate the supplied refrigerant by heat-exchanging with air. The heat pump system further includes a first expansion valve provided on the refrigerant line between the external heat-exchanger and the evaporator. The heat pump system further includes an accumulator provided on the refrigerant line between the evaporator and the compressor. The heat pump system further includes a first connection line having a first end connected to the accumulator. The heat pump system further includes a chiller provided on the first connection line, and configured to heat-exchange the refrigerant introduced through the first connection line with a selectively introduced coolant to adjust a temperature of the coolant. The heat pump system further includes a second expansion valve provided on the refrigerant line between the external heat-exchanger and the first expansion valve, and connected to a second end of the first connection line. The heat pump system further includes a gas injection device connected to the refrigerant line between the internal condenser and the external heat-exchanger, and configured to selectively expand the refrigerant supplied from the internal condenser or the external heat-exchanger and flow the expanded refrigerant, and selectively supply a partial refrigerant among the supplied refrigerant to the compressor to increase a flow rate of the refrigerant circulating through the refrigerant line. The heat pump system further includes a second connection line having a first end connected to the refrigerant line between the compressor and the internal condenser, where a flow direction of the refrigerant is controlled depending on at least one mode of the heat pump system for a temperature control of a vehicle interior.

The gas injection device may include a flash tank configured to separate an interiorly introduced refrigerant into a gaseous refrigerant and a liquid refrigerant and selectively discharge the separated refrigerant. The gas injection device may further include a third expansion valve provided on the refrigerant line between the internal condenser and the external heat-exchanger. The gas injection device may further include a first line having a first end connected to the flash tank and a second end connected to the third expansion valve. The gas injection device may further include a second line connecting the compressor and the flash tank, and configured to selectively supply the gaseous refrigerant from the flash tank to the compressor. The gas injection device may further include a third line having a first end connected to the flash tank.

The flash tank may be operated when the expanded refrigerant is supplied through the first line, and supplies a gaseous refrigerant among the supplied refrigerant to the compressor through the second line, to increase the flow rate of the refrigerant circulating through the refrigerant line.

When an operation of the gas injection device is required, the third expansion valve may expand the refrigerant supplied from the internal condenser or the external heat-exchanger, and may supply the expanded refrigerant to the flash tank through the first line.

A heat pump system may further include a fourth expansion valve provided on the refrigerant line between the third expansion valve and the external heat-exchanger, and connected to a second end of the third line and a second end of the second connection line. The heat pump system may further include a third connection line having a first end connected to the third expansion valve, and a second end connected to the refrigerant line between the external heat-exchanger and the second expansion valve. The heat pump system may further include a fourth connection line having a first end connected to the second expansion valve and a second end connected to the third line.

The second expansion valve, the third expansion valve, and the fourth expansion valve may be 4-way expansion valves selectively operated in the at least one mode, and configured to selectively expand the refrigerant while controlling the flow direction of the supplied refrigerant.

The at least one mode may include a first cooling mode for cooling the vehicle interior, without operating the gas injection device, a second cooling mode for cooling the vehicle interior, by operating the gas injection device, a first heating mode for heating the vehicle interior, without operating the gas injection device, and a second heating mode for heating the vehicle interior, by operating the gas injection device, a first hot gas heating mode for heating the vehicle interior by using the refrigerant without recollecting heat, without operating the gas injection device, and a second hot gas heating mode for heating the vehicle interior by using the refrigerant without recollecting heat, by operating the gas injection device.

In the first cooling mode, a portion of the refrigerant line connecting a first end of the second connection line to the internal condenser, the third expansion valve, and the fourth expansion valve may be closed by the third expansion valve and the fourth expansion valve. In the first cooling mode, a portion of the refrigerant line connecting the fourth expansion valve to the external heat-exchanger and the second expansion valve may be opened by the second expansion valve. In the first cooling mode, a portion of the refrigerant line connecting the second expansion valve to the first expansion valve, the evaporator, the accumulator, and the compressor may be opened by the first expansion valve. In the first cooling mode, the first line may be closed by the third expansion valve, the second line may be closed, the third line may be closed by the fourth expansion valve, and the second connection line may be opened by the fourth expansion valve, so that the refrigerant discharged from the compressor flows to the second connection line. In the first cooling mode, the third connection line may be closed by the third expansion valve, and the fourth connection line may be closed by the second expansion valve. In the first cooling mode, the first expansion valve may expand the refrigerant introduced through the refrigerant line, and may supply the expanded refrigerant to the evaporator. In the first cooling mode, the second expansion valve may flow the refrigerant introduced from the external heat-exchanger through the refrigerant line, to the refrigerant line connected to the first expansion valve, without expansion. In the first cooling mode, an operation of the third expansion valve is stopped, and the fourth expansion valve may supply the refrigerant introduced through the second connection line, to the external heat-exchanger, without expansion.

In the second cooling mode, a portion of the refrigerant line connecting a first end of the second connection line to the internal condenser, the third expansion valve, and the fourth expansion valve may be closed by the third expansion valve and the fourth expansion valve. In the second cooling mode, a portion of the refrigerant line connecting the fourth expansion valve to the external heat-exchanger and a second end of the third connection line may be opened by the fourth expansion valve. In the second cooling mode, a portion of the refrigerant line connecting the second end of the third connection line to the second expansion valve may be closed. In the second cooling mode, a portion of the refrigerant line connecting the second expansion valve to the first expansion valve, the evaporator, the accumulator, and the compressor may be opened by the first expansion valve. In the second cooling mode, the first line may be opened by the third expansion valve, and the second line may be opened. In the second cooling mode, a portion of the third line connecting the flash tank and a second end of the fourth connection line may be opened. In the second cooling mode, a remaining portion of the third line connecting the second end of the fourth connection line to the fourth expansion valve may be closed. In the second cooling mode, the second connection line may be opened by the fourth expansion valve, so that the refrigerant discharged from the compressor flows to the second connection line. In the second cooling mode, the third connection line may be opened by the third expansion valve, the fourth connection line may be opened by the second expansion valve, and the first expansion valve may expand the refrigerant introduced through the refrigerant line, and may supply the expanded refrigerant to the evaporator. In the second cooling mode, the second expansion valve may flow the refrigerant introduced through the fourth connection line, to the refrigerant line connected to the first expansion valve, without expansion. In the second cooling mode, the third expansion valve may expand the refrigerant introduced through a portion of the refrigerant line and the third connection line from the external heat-exchanger, and may flow the expanded refrigerant to the first line. In the second cooling mode, the fourth expansion valve may supply the refrigerant introduced through the second connection line, to the external heat-exchanger, without expansion, and the flash tank may supply the gaseous refrigerant among the interiorly introduced refrigerant to the compressor through the opened second line.

When cooling of a battery module is required in the first cooling mode and the second cooling mode, the first connection line may be opened by the second expansion valve, and the second expansion valve may expand a partial refrigerant among the refrigerant introduced from the external heat-exchanger so that the expanded refrigerant may be introduced into the chiller, and may flow the expanded refrigerant to the first connection line.

In the first heating mode, a portion of the refrigerant line connecting the compressor, the internal condenser, the third expansion valve, the fourth expansion valve, the external heat-exchanger, and the second expansion valve may be opened by the second expansion valve the third expansion valve, and the fourth expansion valve. In the first heating mode, a portion of the refrigerant line connecting the accumulator and the compressor may be opened. In the first heating mode, the first connection line may be opened by the second expansion valve, the first line may be closed by the third expansion valve, the second line may be closed, and the third line may be closed by the fourth expansion valve. In the first heating mode, the second connection line may be closed by the fourth expansion valve, the third connection line may be closed by the third expansion valve, the fourth connection line may be closed by the second expansion valve, and the second expansion valve may expand the refrigerant supplied from the external heat-exchanger, and may supply the expanded refrigerant to the chiller through the first connection line. In the first heating mode, the third expansion valve may expand the refrigerant introduced from the internal condenser through the refrigerant line, and may supply the expanded refrigerant to the fourth expansion valve, and the fourth expansion valve may supply the refrigerant introduced through a portion of the refrigerant line, to the external heat-exchanger, without expansion.

In the second heating mode, a portion of the refrigerant line connecting the compressor, the internal condenser, and the third expansion valve may be opened by the third expansion valve. In the second heating mode, a portion of the refrigerant line connecting the third expansion valve to the fourth expansion valve may be closed by the third expansion valve and the fourth expansion valve, In the second heating mode, a portion of the refrigerant line connecting the accumulator and the compressor may be opened. In the second heating mode, the first connection line may be opened by the second expansion valve, the first line may be opened by the third expansion valve, the second line may be opened, and the third line may be opened by the fourth expansion valve. In the second heating mode, the second connection line may be closed by the fourth expansion valve, the third connection line may be closed by the third expansion valve, and the fourth connection line may be closed by the second expansion valve. In the second heating mode, the second expansion valve may expand the refrigerant supplied from the external heat-exchanger, and may supply the expanded refrigerant to the chiller through the first connection line. In the second heating mode, the third expansion valve may expand the refrigerant introduced from the internal condenser through the refrigerant line, and may flow the expanded refrigerant to the first line. In the second heating mode, the fourth expansion valve may expand the refrigerant introduced through the third line, and may supply the expanded refrigerant to the external heat-exchanger. In the second heating mode, the flash tank may supply the gaseous refrigerant among the interiorly introduced refrigerant to the compressor through the opened second line.

When dehumidification is required in the first heating mode and the second heating mode, a portion of the refrigerant line connecting the second expansion valve to the first expansion valve, the evaporator, and the accumulator may be opened by the second expansion valve. The first expansion valve may expand the refrigerant introduced through the refrigerant line, and may supply the expanded refrigerant to the evaporator. The second expansion valve may flow a partial refrigerant among the refrigerant supplied from the external heat-exchanger to the refrigerant line connected to the first expansion valve, without expansion.

In the first hot gas heating mode, a portion of the refrigerant line connecting the compressor, the internal condenser, the third expansion valve, and the fourth expansion valve may be opened by the third expansion valve and the fourth expansion valve. In the first hot gas heating mode, a portion of the refrigerant line connecting the accumulator and the compressor may be opened. In the first hot gas heating mode, a portion of the refrigerant line connecting the second expansion valve to the first expansion valve, the evaporator, and the accumulator may be closed by the second expansion valve. In the first hot gas heating mode, a portion of the refrigerant line connecting a second end of the third connection line to the second expansion valve may be opened by the second expansion valve, the first connection line may be opened by the second expansion valve, the first line may be closed by the third expansion valve, the second line may be closed, the third line may be closed by the fourth expansion valve, and the second connection line may be opened by the fourth expansion valve. In the first hot gas heating mode, the third connection line may be opened by the third expansion valve, the fourth connection line may be closed by the second expansion valve, and an operation of the first expansion valve is stopped. In the first hot gas heating mode, the second expansion valve may flow the refrigerant introduced through the third connection line and a portion of the refrigerant line, to the first connection line, without expansion. In the first hot gas heating mode, the third expansion valve may flow the refrigerant introduced from the internal condenser through the refrigerant line, and the refrigerant introduced from the fourth expansion valve through a portion of the refrigerant line, together to the third connection line. In the first hot gas heating mode, the fourth expansion valve may expand the refrigerant introduced from the compressor through the second connection line, and may flow the expanded refrigerant to a portion of the refrigerant line connected to the third expansion valve.

The third expansion valve may be configured to expand the refrigerant introduced from the internal condenser through the refrigerant line, and flow the refrigerant introduced from the fourth expansion valve through a portion of the refrigerant line, without expansion.

The refrigerant introduced from the fourth expansion valve through a portion of the refrigerant line may not be expanded.

In the second hot gas heating mode, a portion of the refrigerant line connecting the compressor, the internal condenser, and the third expansion valve may be opened by the third expansion valve. In the second hot gas heating mode, a portion of the refrigerant line connecting the third expansion valve to the fourth expansion valve, the external heat-exchanger, and the second expansion valve may be closed by the second expansion valve, the third expansion valve, and the fourth expansion valve. In the second hot gas heating mode, a portion of the refrigerant line connecting the second expansion valve to the first expansion valve, the evaporator, and the accumulator may be closed by the second expansion valve. In the second hot gas heating mode, a portion of the refrigerant line connecting the accumulator and the compressor may be opened, the first connection line may be opened by the second expansion valve, the first line may be opened by the third expansion valve, the second line may be opened, and the third line may be opened by the fourth expansion valve. In the second hot gas heating mode, the second connection line may be opened by the fourth expansion valve, the third connection line may be closed by the third expansion valve, and the fourth connection line may be opened by the second expansion valve. In the second hot gas heating mode, an operation of the first expansion valve is stopped, and the second expansion valve may flow the refrigerant introduced through the fourth connection line, to the first connection line, without expansion. In the second hot gas heating mode, the third expansion valve may expand the refrigerant introduced from the internal condenser through the refrigerant line, and may flow the expanded refrigerant to the first line. In the second hot gas heating mode, the flash tank may supply the gaseous refrigerant among the interiorly introduced refrigerant to the compressor through the opened second line, and flow the liquid refrigerant to a portion of the third line. In the second hot gas heating mode, the fourth expansion valve may expand the refrigerant introduced from the compressor through the second connection line, and flow the expanded refrigerant to a remaining third line connecting the fourth expansion valve and a second end of the fourth connection line.

A heat pump system may further include an electrical component and a battery module through which the coolant circulates, where the chiller may be connected to the electrical component through a first coolant line through which the coolant circulates, and connected to the battery module through a second coolant line through which the coolant circulates.

When a waste heat of the electrical component is to be recollected, the first coolant line may be opened to connect the chiller and the electrical component.

When the battery module is to be cooled, or when a waste heat of the battery module is to be recollected, the second coolant line may be opened to connect the chiller and the battery module.

As described above, according to a heat pump system for a vehicle according to an embodiment of the present disclosure, cooling and heating performance may be improved by applying a gas injection device selectively operating in an air conditioning mode of vehicle interior to increase the flow rate of the refrigerant.

In addition, according to the present disclosure, the performance of the system by using the gas injection device may be maximized while minimizing the required system components, and accordingly, streamlining and simplification of the system may be achieved.

In addition, according to the present disclosure, an opening/closing door that was provided inside the conventional HVAC module may be removed, so that the HVAC module may become compact by reducing the number of parts of the HVAC module, thereby reducing manufacturing man-hours and improving productivity.

In addition, according to the present disclosure, through streamlining of an entire system, it is possible to reduce manufacturing cost and weight and improve space utilization of a vehicle or a system for the vehicle.

### BRIEF DESCRIPTION OF THE DRAWINGS

FIG. 1 is a block diagram of a heat pump system for a vehicle according to an embodiment of the present disclosure.

FIG. 2 is an operation diagram according to a first cooling mode of a heat pump system for a vehicle according to an embodiment of the present disclosure.

FIG. 3 is an operation diagram according to a second cooling mode of a heat pump system for a vehicle according to an embodiment of the present disclosure.

FIG. 4 is an operation diagram according to a first heating mode of a heat pump system for a vehicle according to an embodiment of the present disclosure.

FIG. 5 is an operation diagram according to a second heating mode of a heat pump system for a vehicle according to an embodiment of the present disclosure.

FIG. 6 is an operation diagram according to a first hot gas heating mode of a heat pump system for a vehicle according to an embodiment of the present disclosure.

FIG. 7 is an operation diagram according to a second hot gas heating mode of a heat pump system for a vehicle according to an embodiment of the present disclosure.

### DETAILED DESCRIPTION

Embodiments of the present disclosure are hereinafter described in detail with reference to the accompanying drawings.

Embodiments of the present disclosure in the present specification and the constructions depicted in the drawings are only example embodiments of the present disclosure, and do not cover the entire scope of the present disclosure. Therefore, it should be understood that there may be various equivalents to and variations of the disclosed embodiments at a time that the technical concepts of this specification are applied.

In order to clarify the present disclosure, parts that are not related to the description may have been omitted. Further, the same elements or equivalents are referred to with the same reference numerals throughout the specification.

Also, the size and thickness of each element may be arbitrarily shown in the drawings, but the present disclosure is not necessarily limited thereto. In the drawings, the thickness of layers, films, panels, regions, and the like, may be exaggerated for clarity.

In addition, unless explicitly described to the contrary, the word “comprise”, “have”, “include”, and variations thereof such as “comprises” or “comprising”, should be understood to imply the inclusion of stated elements but not the exclusion of any other elements.

Furthermore, each of terms, such as “ . . . unit”, “ . . . means”, “ . . . portions”, “ . . . part”, and “ . . . member” described in the specification, mean a unit of a comprehensive element that performs at least one function or operation. When a component, device, unit, module, controller, detector, element, or the like of the present disclosure is described as having a purpose or performing an operation, function, or the like, the component, device, unit, module, controller, detector, or element should be considered herein as being “configured to” meet that purpose or to perform that operation or function. The present disclosure describes a controller and a data detector for a cooling system. The controller, detector, or other such components may separately embody or be included with a processor and a memory, such as a non-transitory computer readable media, as part of the controller or component.

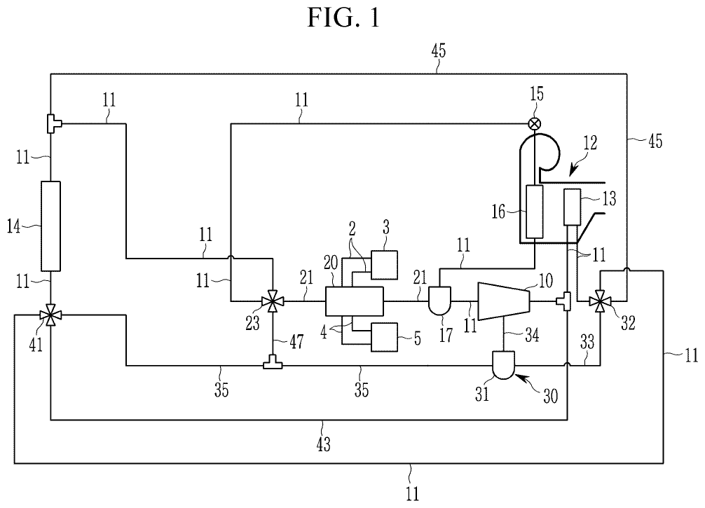

FIG. 1 is a block diagram of a heat pump system for a vehicle according to an embodiment of the present disclosure.

A heat pump system for a vehicle according to an embodiment of the present disclosure may improve the cooling and heating performance by applying a gas injection device 30 that selectively operates in a selected air conditioning mode of a vehicle interior and thereby increasing a flow rate of a refrigerant.

Referring to FIG. 1, the heat pump system may include an electrical component 3 and a battery module 5 through which a coolant circulates, respectively.

In addition, the heat pump system may include a compressor 10, a Heating, Ventilation, and Air Conditioning (HVAC) module 12, an internal condenser 13, an external heat-exchanger 14, a first expansion valve 15, an evaporator 16, an accumulator 17, a chiller 20, a first connection line 21, a second expansion valve 23, and the gas injection device 30.

The electrical component 3 may be connected to the chiller 20 through a first coolant line 2 through which the coolant circulates. When the waste heat of the electrical component 3 is to be recollected while heating the vehicle interior, the first coolant line 2 may be opened to connect the chiller 20 and the electrical component 3.

The electrical component 3 may include an electric power control unit (EPCU), a motor, an inverter, an on-board charger (OBC), an autonomous driving controller, or the like.

The electrical power control apparatus, the inverter, the motor, or the autonomous driving controller may generate heat during driving of the vehicle, and the charger may generate heat when charging the battery module 5.

In other words, when the waste heat of the electrical component 3 is to be recollected while heating the vehicle interior, heat generated from the electrical power control apparatus, the motor, the inverter, the charger, or the autonomous driving controller may be recollected.

In an embodiment of the present disclosure, the battery module 5 may be connected to the chiller 20 through a second coolant line 4 through which the coolant circulates.

When the battery module 5 is to be cooled while cooling the vehicle interior, or when the waste heat of the battery module 5 is to be recollected while heating the vehicle interior, the second coolant line 4 may be opened to connect the chiller 20 and the battery module 5.

In other words, the electrical component 3 and the battery module 5 may be cooled in a water-cooled manner through the first coolant line 2 and the second coolant line 4.

A water pump (not shown) may be provided on, i.e., connected to or along, each of the first coolant line 2 and the second coolant line 4, and the coolant may be selectively circulated by an operation of respective water pumps to impart flow of the coolant through the coolant lines.

In an embodiment of the present disclosure, the compressor 10 may compress the supplied refrigerant and flow the compressed refrigerant to a refrigerant line 11 so that the refrigerant may circulate along the refrigerant line 11.

The internal condenser 13 and the evaporator 16 connected to the compressor 10 through the refrigerant line 11 may be provided inside the HVAC module 12.

The high-temperature refrigerant supplied to the internal condenser 13 may increase a temperature of ambient air passing through the internal condenser 13. In other words, the introduced ambient air may be converted to a high-temperature state while passing through the internal condenser 13 and then introduced into the vehicle interior, thereby implementing heating of the vehicle interior.

When cooling the vehicle interior, while the refrigerant is not supplied to the internal condenser 13, the low-temperature refrigerant may be supplied to the evaporator 16. Then, the low-temperature refrigerant supplied to the evaporator 16 may cool the ambient air passing through the evaporator 16. The cooled ambient air may be introduced into the vehicle interior, thereby cooling the vehicle interior.

In an embodiment of the present disclosure, the external heat-exchanger 14 may be connected to the internal condenser 13 through the refrigerant line 11. The external heat-exchanger 14 may be disposed at an upstream end, i.e., a front of the vehicle (relative to the normal driving or movement direction).

Accordingly, the external heat-exchanger 14 may condense or evaporate the refrigerant by heat-exchanging the introduced refrigerant with the ambient air introduced during driving of the vehicle. In other words, the external heat-exchanger 14 may be an air-cooled heat-exchanger configured to heat-exchange the introduced refrigerant with the ambient air.

The first expansion valve 15 may be provided on, i.e., connected to or along, the refrigerant line 11 connecting the external heat-exchanger 14 and the evaporator 16. The first expansion valve 15 may expand the introduced refrigerant.

The accumulator 17 may be provided on the refrigerant line 11 between the evaporator 16 and the compressor 10.

The accumulator 17 may only supply the gaseous refrigerant (of the supplied refrigerant separated into a gaseous refrigerant and a liquid refrigerant) to the compressor 10, and thereby improve the efficiency and durability of the compressor 10.

In an embodiment of the present disclosure, the chiller 20 may adjust a temperature of the coolant selectively supplied through the first coolant line 2 or the second coolant line 4 by heat-exchanging the supplied refrigerant with the coolant.

In other words, the chiller 20 may be a water-cooled heat-exchanger configured to heat-exchange an interiorly introduced refrigerant with the coolant.

The chiller 20 may be connected to the refrigerant line 11 through the first connection line 21. A first end of the first connection line 21 may be connected to the accumulator 17.

The second expansion valve 23 may be provided on, i.e., connected to or along, the refrigerant line 11 between the external heat-exchanger 14 and the first expansion valve 15. A second end of the first connection line 21 may be connected to the second expansion valve 23.

In other words, the chiller 20 may adjust the temperature of the coolant by heat-exchanging the coolant selectively introduced through the first coolant line 2 or the second coolant line 4 with the refrigerant selectively supplied from the second expansion valve 23 through the first connection line 21.

Accordingly, the coolant heat-exchanged with the refrigerant at the chiller 20 may be selectively supplied to the electrical component 3 and the battery module 5, to adjust temperatures of the battery module 5 and the electrical component 3.

When the electrical component 3 or the battery module 5 is to be cooled by using the coolant heat-exchanged with the refrigerant while cooling the vehicle interior, the second expansion valve 23 may expand the refrigerant introduced through the first connection line 21 and flow the expanded refrigerant to the chiller 20.

In other words, when the electrical component 3 or the battery module 5 is to be cooled while cooling the vehicle interior, the second expansion valve 23 may expand the refrigerant introduced through the first connection line 21 to lower its temperature, and flow the expanded refrigerant to the chiller 20, to further lower temperature of the coolant passing through an interior of the chiller 20.

Accordingly, the coolant cooled while passing through the chiller 20 may be introduced into the electrical component 3 or the battery module 5, thereby achieving more efficient cooling.

When the waste heat from the electrical component 3 or the battery module 5 is to be recollected while heating the vehicle interior, the second expansion valve 23 may expand the refrigerant introduced through the first connection line 21, and may supply the expanded refrigerant to the chiller 20.

Accordingly, the chiller 20 may evaporate the refrigerant through heat-exchange with the coolant supplied through the first coolant line 2 or the second coolant line 4.

The chiller 20 may recollect the waste heat of the electrical component 3 or the battery module 5 while heat-exchanging the refrigerant supplied from the second expansion valve 23 with the coolant supplied from the electrical component 3 or the battery module 5.

The second expansion valve 23 configured as such may be a 4-way electronic expansion valve configured to selectively expand the refrigerant while controlling the flow direction of the supplied refrigerant.

In addition, the gas injection device 30 may be connected to the refrigerant line 11 between the internal condenser 13 and the external heat-exchanger 14.

The gas injection device 30 may selectively expand the refrigerant supplied from the internal condenser 13 or the external heat-exchanger 14 and flow the expanded refrigerant, and may selectively supply a partial refrigerant among the supplied refrigerant to the compressor 10 to increase the flow rate of the refrigerant circulating through the refrigerant line 11.

The gas injection device 30 configured as such may be selectively operated in at least one mode for a temperature control of the vehicle interior.

The gas injection device 30 may include a flash tank 31, a third expansion valve 32, a first line 33, a second line 34, and a third line 35.

The flash tank 31 may separate a gaseous refrigerant and a liquid refrigerant from among the interiorly introduced refrigerant and selectively discharge the separated refrigerant (i.e., selectively discharge the gaseous refrigerant and the liquid refrigerant).

The third expansion valve 32 may be provided on, i.e., connected to or along, the refrigerant line 11 between the internal condenser 13 and the external heat-exchanger 14.

In an embodiment of the present disclosure, a first end of the first line 33 may be connected to the flash tank 31. A second end of the first line 33 may be connected to the third expansion valve 32.

The first line 33 may selectively supply the refrigerant supplied from the internal condenser 13 to the flash tank 31 according to an operation of the third expansion valve 32.

The third expansion valve 32 may selectively expand the refrigerant supplied from the internal condenser 13 or the external heat-exchanger 14.

The third expansion valve 32 may flow the expanded refrigerant or the unexpanded refrigerant to the refrigerant line 11 or the first line 33.

In other words, when an operation of the gas injection device 30 is required, the third expansion valve 32 may expand the refrigerant supplied from the internal condenser 13 or the external heat-exchanger 14, and may supply the expanded refrigerant to the flash tank 31 through the first line 33.

The third expansion valve 32 configured as such may be a 4-way electronic expansion valve selectively operated in the at least one mode, and configured to selectively expand the refrigerant while controlling the flow direction of the refrigerant.

In an embodiment of the present disclosure, the second line 34 may connect the flash tank 31 and the compressor 10. When the expanded refrigerant is supplied to the flash tank 31, the second line 34 may selectively supply the gaseous refrigerant from the flash tank 31 to the compressor 10.

In other words, the second line 34 may connect the flash tank 31 and the compressor 10 so that the gaseous refrigerant separated at the flash tank 31 may be selectively introduced into the compressor 10.

In an embodiment of the present disclosure, a first end of the third line 35 may be connected to the flash tank 31.

In the gas injection device 30 configured as such, the flash tank 31 may be operated when the expanded refrigerant is supplied in the air conditioning mode of the vehicle interior.

In other words, the flash tank 31 may supply the gaseous refrigerant among the supplied refrigerant to the compressor 10 through the second line 34, to increase the flow rate of the refrigerant circulating through the refrigerant line 11.

The heat pump system configured as such may further include a fourth expansion valve 41, a second connection line 43, a third connection line 45, and a fourth connection line 47.

A first end of the second connection line 43 may be connected to the refrigerant line 11 between the compressor 10 and the internal condenser 13.

The fourth expansion valve 41 may be provided on the refrigerant line 11 between the third expansion valve 32 and the external heat-exchanger 14.

A second end of the third line 35 and a second end of the second connection line 43 may be connected to the fourth expansion valve 41, respectively.

In the at least one mode of the heat pump system, the fourth expansion valve 41 may selectively expand the refrigerant supplied from the flash tank 31 through the third line 35, and may supply the expanded refrigerant to the external heat-exchanger 14.

In addition, in the at least one mode of the heat pump system, the fourth expansion valve 41 may selectively expand the refrigerant supplied from the compressor 10 through the second connection line 43, and may flow the expanded refrigerant to the third line 35 or to a portion of the refrigerant line 11 connected to a second expansion valve 23.

In addition, the fourth expansion valve 41 may supply the refrigerant supplied from the third expansion valve 32 through the refrigerant line 11 in the at least one mode, to the external heat-exchanger 14, without expansion.

The fourth expansion valve may be a 4-way expansion valve selectively operated in the at least one mode, and configured to selectively expand the refrigerant while controlling the flow direction of the supplied refrigerant.

In an embodiment of the present disclosure, a first end of the third connection line 45 may be connected to the third expansion valve 32. A second end of the third connection line 45 may be connected to the refrigerant line 11 between the external heat-exchanger 14 and the second expansion valve 23.

The third connection line 45 may be selectively opened and/or closed by the third expansion valve 32 in the at least one mode of the heat pump system.

In addition, a first end of the fourth connection line 47 may be connected to the second expansion valve 23. A second end of the fourth connection line 47 may be connected to the third line 35.

The fourth connection line 47 may be selectively opened and/or closed by the second expansion valve 23 in the at least one mode of the heat pump system.

In the heat pump system configured as such, depending on the at least one mode for the temperature control of the vehicle interior, the flow direction of the refrigerant may be controlled through an operation control of the gas injection device 30 and an operation control of the second expansion valve 23 and the fourth expansion valve 41.

The at least one mode may include a first cooling mode, a second cooling mode, a first heating mode, a second heating mode, a first hot gas heating mode, and second hot gas heating mode.

In the first cooling mode, the vehicle interior may be cooled without operating the gas injection device 30.

In the second cooling mode, the vehicle interior may be cooled while operating the gas injection device 30.

In the first heating mode, the vehicle interior may be heated without operating the gas injection device 30.

In the second heating mode, the vehicle interior may be heated while operating the gas injection device 30.

In the first hot gas heating mode, the vehicle interior may be heated by using the refrigerant without recollecting heating, without operating the gas injection device 30.

In addition, in the second hot gas heating mode, the vehicle interior may be heated by using the refrigerant without recollecting heat, while operating the gas injection device 30.

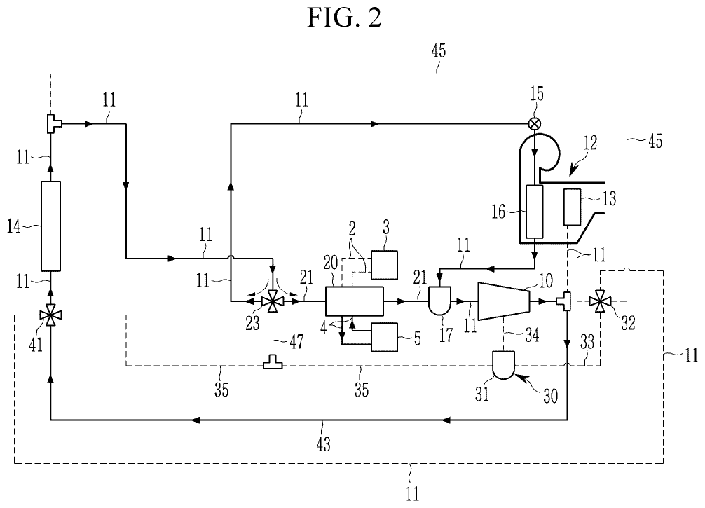

An operation and action of a heat pump system according to an embodiment of the present disclosure configured as such are described in detail below with reference to FIGS. 2-7 .

An operation and action of a heat pump system for a vehicle according to an embodiment of the present disclosure configured as described above are described in detail below with reference to FIG. 2-7 .

An operation in the first cooling mode for cooling the vehicle interior, in which the gas injection device 30 is not operated, is described in detail below with reference to FIG. 2.

FIG. 2 is an operation diagram according to the first cooling mode of a heat pump system for a vehicle according to an embodiment of the present disclosure.

Referring to FIG. 2, in the first cooling mode, a portion of the refrigerant line 11 connecting the first end of the second connection line 43 to the internal condenser 13, the third expansion valve 32, and the fourth expansion valve 41 may be closed by the third expansion valve 32 and the fourth expansion valve 41.

In addition, a portion of the refrigerant line 11 connecting the fourth expansion valve 41 to the external heat-exchanger 14 and the second expansion valve 23 may be opened by the second expansion valve 23.

In addition, a portion of the refrigerant line 11 connecting the second expansion valve 23 to the first expansion valve 15, the evaporator 16, the accumulator 17, and the compressor 10 may be opened by the first expansion valve 15.

In an embodiment of the present disclosure, the first line 33 may be closed by the third expansion valve 32. In addition, the second line 34 may be closed.

In addition, the third line 35 may be closed by the fourth expansion valve 41.

In an embodiment of the present disclosure, the second connection line 43 may be opened by the fourth expansion valve 41 so that the refrigerant discharged from the compressor 10 flows to the second connection line 43.

In addition, the third connection line 45 may be closed by the third expansion valve 32. The operation of the third expansion valve 32 may be stopped.

In addition, the fourth connection line 47 may be closed by the second expansion valve 23.

In such a state, the refrigerant compressed at the compressor 10 may be introduced into the fourth expansion valve 41 along a portion of the refrigerant line 11 and the second connection line 43.

The fourth expansion valve 41 may supply the refrigerant introduced through the second connection line 43 to the external heat-exchanger 14 through an opened portion of the refrigerant line 11 without expansion.

The external heat-exchanger 14 may condense the refrigerant supplied from the fourth expansion valve 41 through heat-exchange with ambient air.

The refrigerant discharged from the external heat-exchanger 14 may be introduced into the second expansion valve 23 along the refrigerant line 11.

The second expansion valve 23 may flow the refrigerant introduced from the external heat-exchanger 14 through the refrigerant line 11, to the refrigerant line 11 connected to the first expansion valve 15, without expansion.

Accordingly, the refrigerant discharged from the second expansion valve 23 may be introduced into the first expansion valve 15 along the refrigerant line 11.

The first expansion valve 15 may expand the refrigerant introduced through the refrigerant line, and may supply the expanded refrigerant to the evaporator 16.

In such a state, the ambient air introduced into the HVAC module 12 may be cooled while passing through the evaporator 16 by the low-temperature refrigerant introduced into the evaporator 16. The cooled ambient air may cool the vehicle interior by being directly introduced into the vehicle interior after passing through the internal condenser 13 that is not supplied with the refrigerant.

In addition, the refrigerant having passed through the evaporator 16 may be introduced into the accumulator 17 along the refrigerant line 11. Thereafter, the refrigerant may pass through the accumulator 17 and be introduced into the compressor 10.

When cooling of the battery module 5 is required in the first cooling mode, the first connection line 21 may be opened by the second expansion valve 23.

The second expansion valve 23 may expand a partial refrigerant among the refrigerant introduced from the external heat-exchanger 14 so that the expanded refrigerant may be introduced into the chiller 20, and may flow the expanded refrigerant to the first connection line 21.

In other words, a partial refrigerant among the refrigerant introduced into the second expansion valve 23 from the external heat-exchanger 14 may flow to the refrigerant line 11 connected to the first expansion valve 15 without expansion by the second expansion valve 23.

A remaining refrigerant among the refrigerant introduced into the second expansion valve 23 from the external heat-exchanger 14 may be introduced into the chiller 20 along the first connection line 21 in an expanded state by the second expansion valve 23.

The refrigerant introduced into the chiller 20 may cool the coolant while heat-exchanging with the coolant supplied from the battery module 5 through the second coolant line 4.

The coolant cooled at the chiller 20 may be supplied to the battery module 5 along the second coolant line 4. Accordingly, the battery module 5 may be efficiently cooled by the coolant cooled at the chiller 20.

In other words, the coolant circulated through the second coolant line 4 may efficiently cool the battery module 5 while repeatedly performing the above-described operation.

The refrigerant having passed through the chiller 20 may be introduced into the accumulator 17 together with the refrigerant discharged from the evaporator 16. The refrigerant may pass through the accumulator 17 and be introduced into the compressor 10. The introduced refrigerant may be compressed by the compressor 10.

The refrigerant compressed at the compressor 10 may be supplied to the external heat-exchanger 14 along the refrigerant line 11 and the second connection line 43. While repeatedly performing the above-described processes, the heat pump system may efficiently cool the vehicle interior.

When cooling of the battery module 5 is required in the first cooling mode, the heat pump system may efficiently cool the battery module 5 by using the low-temperature coolant cooled at the chiller 20.

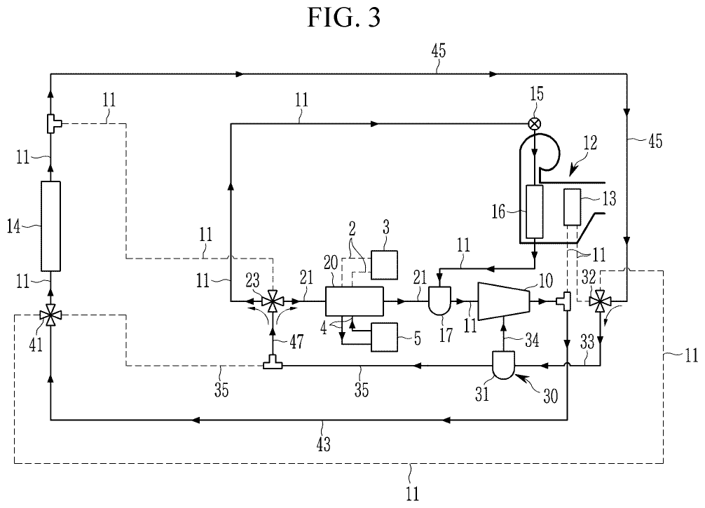

In an embodiment of the present disclosure, an operation in the second cooling mode for cooling the vehicle interior, in which the gas injection device 30 is operated, is described in detail below with reference to FIG. 3.

FIG. 3 is an operation diagram according to the second cooling mode of a heat pump system for a vehicle according to an embodiment of the present disclosure.

Referring to FIG. 3, a portion of the refrigerant line 11 connecting the first end of the second connection line 43 to the internal condenser 13, the third expansion valve 32, and the fourth expansion valve 41 may be closed by the third expansion valve 32 and the fourth expansion valve 41.

In addition, a portion of the refrigerant line 11 connecting the fourth expansion valve 41 to the external heat-exchanger 14 and the second end of the third connection line 45 may be opened by the fourth expansion valve 41.

A portion of the refrigerant line 11 connecting the second end of the third connection line 45 to the second expansion valve 23 may be closed by the second expansion valve 23.

In addition, a portion of the refrigerant line 11 connecting the second expansion valve 23 to the first expansion valve 15, the evaporator 16, the accumulator 17, and the compressor 10 may be opened by the first expansion valve 15.

In an embodiment of the present disclosure, the first line 33 may be opened by the third expansion valve 32. The second line 34 may be opened.

A portion of the third line 35 connecting the flash tank 31 and the second end of the fourth connection line 47 may be opened. A remaining portion of the third line 35 connecting the second end of the fourth connection line 47 to the fourth expansion valve 41 may be closed by the fourth expansion valve 41.

The second connection line 43 may be opened by the fourth expansion valve 41 so that the refrigerant discharged from the compressor 10 flows to the second connection line 43.

The third connection line 45 may be opened by the third expansion valve 32. In addition, the fourth connection line 47 may be opened by the second expansion valve 23.

In such a state, the refrigerant compressed at the compressor 10 may be introduced into the fourth expansion valve 41 along a portion of the refrigerant line 11 and the second connection line 43.

The fourth expansion valve 41 may supply the refrigerant introduced through the second connection line 43 to the external heat-exchanger 14 through an opened portion of the refrigerant line 11 without expansion.

The external heat-exchanger 14 may condense the refrigerant supplied from the fourth expansion valve 41 through heat-exchange with the ambient air.

The refrigerant discharged from the external heat-exchanger 14 may be introduced into the third expansion valve 32 through a portion of the refrigerant line 11 and the third connection line 45.

The third expansion valve 32 may expand the refrigerant introduced through a portion of the refrigerant line 11 and the third connection line 45 from the external heat-exchanger 14, and may supply the expanded refrigerant to the flash tank 31 through the first line 33.

Accordingly, the expanded refrigerant may be introduced into the flash tank 31. The flash tank 31 may supply the gaseous refrigerant among the interiorly introduced refrigerant to the compressor 10 through the opened second line 34.

In other words, the gas injection device 30 may flow the gaseous refrigerant separated while passing through the flash tank 31 back to the compressor 10 through the second line 34, to increase the flow rate of the refrigerant circulating through the refrigerant line 11.

The liquid refrigerant stored in the flash tank 31 may be introduced into the fourth connection line 47 along an opened portion of the third line 35.

The refrigerant introduced into the fourth connection line 47 may be supplied to the second expansion valve 23.

The second expansion valve 23 may flow the refrigerant introduced through a portion of the third line 35 and the fourth connection line 47 from the flash tank 31, to the refrigerant line 11 connected to the first expansion valve 15, without expansion.

Accordingly, the refrigerant discharged from the second expansion valve 23 may be introduced into the first expansion valve 15 along the refrigerant line 11.

The first expansion valve 15 may expand the refrigerant introduced through the refrigerant line, and may supply the expanded refrigerant to the evaporator 16.

In such a state, the ambient air introduced into the HVAC module 12 may be cooled while passing through the evaporator 16 by the low-temperature refrigerant introduced into the evaporator 16. The cooled ambient air may cool the vehicle interior by being directly introduced into the vehicle interior after passing through the internal condenser 13 that is not supplied with the refrigerant.

In addition, the refrigerant having passed through the evaporator 16 may be introduced into the accumulator 17 along the refrigerant line 11. The refrigerant may pass through the accumulator 17 and be introduced into the compressor 10.

When cooling of the battery module 5 is required in the second cooling mode, the first connection line 21 may be opened by the second expansion valve 23.

The second expansion valve 23 may expand a partial refrigerant among the refrigerant introduced through the fourth connection line 47 so that the expanded refrigerant may be introduced into the chiller 20, and may flow the expanded refrigerant to the first connection line 21.

In other words, a partial refrigerant among the refrigerant introduced into the second expansion valve 23 from the flash tank 31 through a portion of the third line 35 and the fourth connection line 47 may flow to the refrigerant line 11 connected to the first expansion valve 15 without expansion by the second expansion valve 23.

A remaining refrigerant among the refrigerant introduced into the second expansion valve 23 from the flash tank 31 through a portion of the third line 35 and the fourth connection line 47 may be introduced into the chiller 20 along the first connection line 21 in an expanded state by the second expansion valve 23.

The refrigerant introduced into the chiller 20 may cool the coolant while heat-exchanging with the coolant supplied from the battery module 5 through the second coolant line 4.

The coolant cooled at the chiller 20 may be supplied to the battery module 5 along the second coolant line 4. Accordingly, the battery module 5 may be efficiently cooled by the coolant cooled at the chiller 20.

In other words, the coolant circulated through the second coolant line 4 may efficiently cool the battery module 5 while repeatedly performing the above-described operation.

The refrigerant having passed through the chiller 20 may be introduced into the accumulator 17 together with the refrigerant discharged from the evaporator 16. The refrigerant may pass through the accumulator 17 and be introduced into the compressor 10. The introduced refrigerant may be compressed by the compressor 10.

While repeatedly performing the above-described processes, the heat pump system may increase the flow rate of the refrigerant flowing along the refrigerant line 11.

In addition, the heat pump system may increase the flow rate of the refrigerant flowing along the refrigerant line 11, to improve the overall cooling performance and efficiency of the system, and to efficiently cool the vehicle interior.

When cooling of the battery module 5 is required in the second cooling mode, the heat pump system may efficiently cool the battery module 5 by using the low-temperature coolant cooled at the chiller 20.

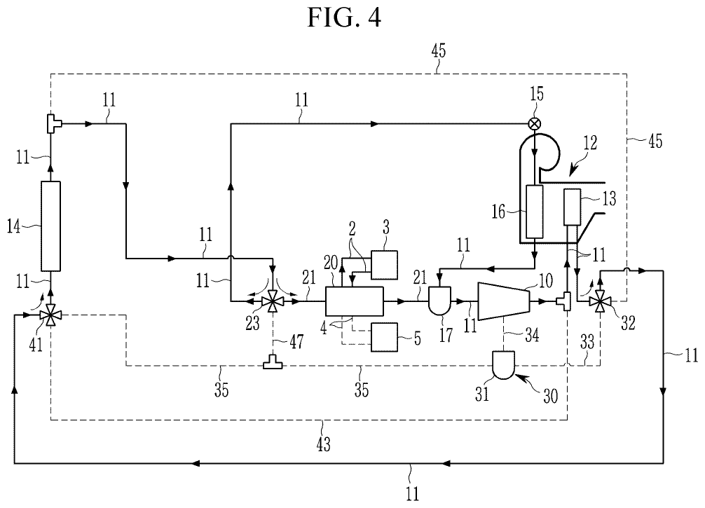

In an embodiment of the present disclosure, an operation in the first heating mode for heating the vehicle interior, in which the gas injection device 30 is not operated, is described in detail below with reference to FIG. 4.

FIG. 4 is an operation diagram according to the first heating mode of a heat pump system for a vehicle according to an embodiment of the present disclosure.

Referring to FIG. 4, in the first heating mode, a portion of the refrigerant line 11 connecting the compressor 10, the internal condenser 13, the third expansion valve 32, the fourth expansion valve 41, the external heat-exchanger 14, and the second expansion valve 23 may be opened by the second expansion valve 23, the third expansion valve 32, and the fourth expansion valve 41.

In addition, a portion of the refrigerant line 11 connecting the accumulator 17 and the compressor 10 may be opened.

In addition, the first connection line 21 may be opened by the second expansion valve 23.

In an embodiment of the present disclosure, the first line 33 may be closed by the third expansion valve 32. In addition, the second line 34 may be closed.

In addition, the third line 35 may be closed by the fourth expansion valve 41.

In an embodiment of the present disclosure, the second connection line 43 may be closed by the fourth expansion valve 41.

The third connection line 45 may be closed by the third expansion valve 32. In addition, the fourth connection line 47 may be closed by the second expansion valve 23.

In such a state, the refrigerant compressed at the compressor 10 may be supplied to the internal condenser 13 along the opened refrigerant line 11. The refrigerant supplied to the internal condenser 13 may increase the temperature of the ambient air introduced into the HVAC module 12.

Accordingly, the ambient air introduced from the outside may be converted to a high-temperature state while passing through the internal condenser 13 and then introduced into the vehicle interior, thereby implementing heating of the vehicle interior.

In addition, the refrigerant condensed at the internal condenser 13 may be introduced into the third expansion valve 32 along the refrigerant line 11. The third expansion valve 32 may expand the refrigerant introduced from the internal condenser 13 through the refrigerant line 11, and may supply the expanded refrigerant to the fourth expansion valve 41.

In other words, the refrigerant expanded at the third expansion valve 32 may be introduced into the fourth expansion valve 41 along an opened portion of the refrigerant line 11.

The fourth expansion valve 41 may supply the refrigerant supplied from the third expansion valve 32 to the external heat-exchanger 14 through an opened portion of the refrigerant line 11 without expansion.

The external heat-exchanger 14 may evaporate the refrigerant while heat-exchanging the ambient air and the refrigerant supplied from the fourth expansion valve 41. The refrigerant may directly absorb the ambient air heat from the ambient air.

The refrigerant evaporated at the external heat-exchanger 14 may be introduced into the second expansion valve 23 along an opened portion of the refrigerant line 11.

The second expansion valve 23 may expand the refrigerant supplied from the external heat-exchanger 14, and may supply the expanded refrigerant to the chiller 20 through the first connection line 21.

The refrigerant introduced into the chiller 20 may cool the coolant while heat-exchanging with the coolant supplied from the electrical component 3 through the first coolant line 2.

The coolant may have its temperature increased by recollecting the waste heat from the electrical component 3 while cooling the electrical component 3. The coolant having its temperature increased through such an operation may be supplied to the chiller 20.

The chiller 20 may recollect the waste heat of the electrical component 3 while heat-exchanging the coolant supplied from the electrical component 3 through the first coolant line 2 with the refrigerant.

The refrigerant having recollected the waste heat of the electrical component 3 at the chiller 20 may be introduced into the compressor 10 by passing through the accumulator 17 along the refrigerant line 11 connected to the first connection line 21.

When dehumidification is required in the first heating mode, a portion of the refrigerant line 11 connecting the second expansion valve 23 to the first expansion valve 15, the evaporator 16, and the accumulator 17 may be opened by the second expansion valve 23.

The second expansion valve 23 may flow a partial refrigerant among the refrigerant supplied from the external heat-exchanger 14, to the refrigerant line 11 connected to the first expansion valve 15, without expansion.

In other words, when dehumidification is required in the first heating mode, the second expansion valve 23 may flow the partial refrigerant among the refrigerant supplied from the external heat-exchanger 14, through the opened refrigerant line 11, without expansion.

The second expansion valve 23 may expand a remaining refrigerant among the refrigerant supplied from the external heat-exchanger 14, and may flow the expanded refrigerant to the first connection line 21.

The first expansion valve 15 may expand the refrigerant supplied from the second expansion valve 23, and may supply the expanded refrigerant to the evaporator 16.

Accordingly, the air introduced into the HVAC module 12 may be dehumidified while passing through the evaporator 16 by the low-temperature refrigerant introduced into the evaporator 16. Thereafter, it may be converted to a high-temperature state while passing through the internal condenser 13 and then introduced into the vehicle interior, thereby smoothly heating and dehumidifying the vehicle interior.

The refrigerant having passed through the evaporator 16 may be introduced into the accumulator 17 along the refrigerant line 11 together with the refrigerant having passed through the chiller 20. The refrigerant may pass through the accumulator 17 and be introduced into the compressor 10. The introduced refrigerant may be compressed by the compressor 10.

The refrigerant compressed at the compressor 10 may be supplied to the internal condenser 13 along the refrigerant line 11.

The heat pump system may repeatedly perform the above-described processes.

As such, a heat pump system according to an embodiment of the present disclosure may recollect the ambient air heat at the external heat-exchanger 14 during driving of the vehicle, and smoothly recollect the waste heat at the chiller 20 from the coolant having its temperature increased while passing through the electrical component 3, thereby improving the overall heating performance and efficiency of the system.

In addition, the present disclosure may improve the heating efficiency and performance while minimizing usage of a separate electric heater.

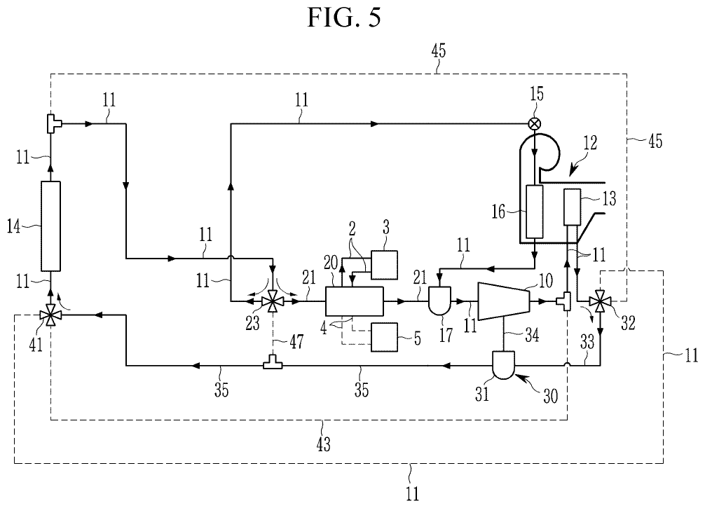

In an embodiment of the present disclosure, the gas injection device 30 may be operated, and an operation in the second heating mode for heating the vehicle interior is described in detail below with reference to FIG. 5.

FIG. 5 is an operation diagram according to the second heating mode of a heat pump system for a vehicle according to an embodiment of the present disclosure.

Referring to FIG. 5, a portion of the refrigerant line 11 connecting the compressor 10, the internal condenser 13, and the third expansion valve 32 may be opened by the third expansion valve 32.

In addition, a portion of the refrigerant line 11 connecting the third expansion valve 32 to the fourth expansion valve 41 may be closed by the third expansion valve 32 and the fourth expansion valve 41.

In addition, a portion of the refrigerant line 11 connecting the accumulator 17 and the compressor 10 may be opened.

In addition, the first connection line 21 may be opened by the second expansion valve 23.

In an embodiment of the present disclosure, the first line 33 may be opened by the third expansion valve 32. The second line 34 may be opened.

In addition, the third line 35 may be opened by the fourth expansion valve 41.

In an embodiment of the present disclosure, the second connection line 43 may be closed by the fourth expansion valve 41.

The third connection line 45 may be closed by the third expansion valve 32. In addition, the fourth connection line 47 may be closed by the second expansion valve 23.

In such a state, the refrigerant compressed at the compressor 10 may be supplied to the internal condenser 13 along the opened refrigerant line 11. The refrigerant supplied to the internal condenser 13 may increase the temperature of the ambient air introduced into the HVAC module 12.

Accordingly, the ambient air introduced from the outside may be converted to a high-temperature state while passing through the internal condenser 13 and then introduced into the vehicle interior, thereby implementing heating of the vehicle interior.

In addition, the refrigerant condensed at the internal condenser 13 may be introduced into the third expansion valve 32 along the refrigerant line 11.

The third expansion valve 32 may expand the refrigerant introduced from the internal condenser 13 through the refrigerant line 11, and may supply the expanded refrigerant to the flash tank 31 through the first line 33.

Accordingly, the expanded refrigerant may be introduced into the flash tank 31. The flash tank 31 may supply the gaseous refrigerant among the interiorly introduced refrigerant to the compressor 10 through the opened second line 34.

In other words, the gas injection device 30 may flow the gaseous refrigerant separated while passing through the flash tank 31 back to the compressor 10 through the second line 34, to increase the flow rate of the refrigerant circulating through the refrigerant line 11.

The liquid refrigerant stored in the flash tank 31 may be introduced into the fourth expansion valve 41 along the opened third line 35.

The fourth expansion valve 41 may expand the refrigerant introduced through the third line 35, and may supply the expanded refrigerant to the external heat-exchanger 14 through the refrigerant line 11.

The external heat-exchanger 14 may evaporate the refrigerant while heat-exchanging the ambient air and the refrigerant supplied from the fourth expansion valve 41. The refrigerant may directly absorb the ambient air heat from the ambient air.

The refrigerant evaporated at the external heat-exchanger 14 may be introduced into the second expansion valve 23 along an opened portion of the refrigerant line 11.

The second expansion valve 23 may expand the refrigerant supplied from the external heat-exchanger 14, and may supply the expanded refrigerant to the chiller 20 through the first connection line 21.

The refrigerant introduced into the chiller 20 may cool the coolant while heat-exchanging with the coolant supplied from the electrical component 3 through the first coolant line 2.

The coolant may have its temperature increased by recollecting the waste heat from the electrical component 3 while cooling the electrical component 3. The coolant having its temperature increased through such an operation may be supplied to the chiller 20.

The chiller 20 may recollect the waste heat of the electrical component 3 while heat-exchanging the coolant supplied from the electrical component 3 through the first coolant line 2 with the refrigerant.

The refrigerant having recollected the waste heat of the electrical component 3 at the chiller 20 may be introduced into the compressor 10 by passing through the accumulator 17 along the refrigerant line 11 connected to the first connection line 21.

When dehumidification is required in the second heating mode, a portion of the refrigerant line 11 connecting the second expansion valve 23 to the first expansion valve 15, the evaporator 16, and the accumulator 17 may be opened by the second expansion valve 23.

The second expansion valve 23 may flow the partial refrigerant among the refrigerant supplied from the external heat-exchanger 14, to the refrigerant line 11 connected to the first expansion valve 15, without expansion.

In other words, when dehumidification is required in the second heating mode, the second expansion valve 23 may flow the partial refrigerant among the refrigerant supplied from the external heat-exchanger 14, through the opened refrigerant line 11, without expansion.

The second expansion valve 23 may expand a remaining refrigerant among the refrigerant supplied from the external heat-exchanger 14, and may flow the expanded refrigerant to the first connection line 21.

The first expansion valve 15 may expand the refrigerant supplied from the second expansion valve 23, and may supply the expanded refrigerant to the evaporator 16.

Accordingly, the air introduced into the HVAC module 12 may be dehumidified while passing through the evaporator 16 by the low-temperature refrigerant introduced into the evaporator 16, and may be converted to a high-temperature state while passing through the internal condenser 13 and then introduced into the vehicle interior, thereby smoothly heating and dehumidifying the vehicle interior.

The refrigerant having passed through the evaporator 16 may be introduced into the accumulator 17 along the refrigerant line 11 together with the refrigerant having passed through the chiller 20. Thereafter, the refrigerant may pass through the accumulator 17 and be introduced into the compressor 10. The introduced refrigerant may be compressed by the compressor 10.

The refrigerant compressed at the compressor 10 may be supplied to the internal condenser 13 along the refrigerant line 11.

The heat pump system may repeatedly perform the above-described processes.

As such, a heat pump system according to an embodiment of the present disclosure may recollect the ambient air heat at the external heat-exchanger 14 during driving of the vehicle, and smoothly recollect the waste heat at the chiller 20 from the coolant having its temperature increased while passing through the electrical component 3, thereby improving the overall heating performance and efficiency of the system.

In addition, the present disclosure may improve the heating efficiency and performance while minimizing usage of a separate electric heater.

In addition, the heat pump system may operate the gas injection device 30 to increase the flow rate of the refrigerant flowing along the refrigerant line 11.

In addition, according to an embodiment of the disclosed the heat pump system, the gas injection device 30 may increase the flow rate of the refrigerant circulating through the refrigerant line 11, thereby maximizing the heating performance.

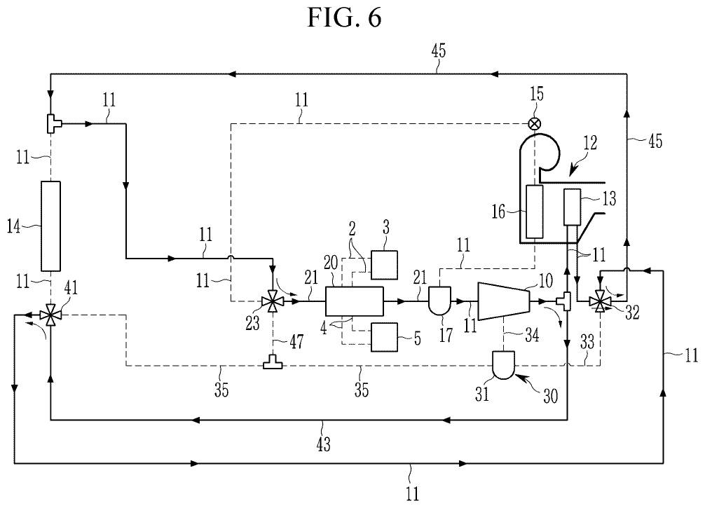

In an embodiment of the present disclosure, an operation in the first hot gas heating mode for heating the vehicle interior by using the refrigerant without recollecting heat, in which the gas injection device 30 is not operated, is described in detail below with reference to FIG. 6.

FIG. 6 is an operation diagram according to a first hot gas heating mode of a heat pump system for a vehicle according to an embodiment of the present disclosure.

Referring to FIG. 6, when the ambient air heat, the waste heat of the electrical component 3, and the waste heat of the battery module 5 are insufficient in terms of generating heat, the heat pump system may not recollect heat.

In other words, when the external temperature is low and heating of the vehicle interior is required while the heat generated by the electrical component 3 and the battery module 5 is not sufficient in an early stage of driving the vehicle, the heat pump system may perform heating of the vehicle interior by directly using the high pressure and high-temperature refrigerant.

As such, heating of the vehicle interior by using only the refrigerant may be referred to as a hot gas heating mode.

In an embodiment of the present disclosure, in the first hot gas heating mode, a portion of the refrigerant line 11 connecting the compressor 10, the internal condenser 13, the third expansion valve 32, and the fourth expansion valve 41 may be opened by the third expansion valve 32 and the fourth expansion valve 41.

In addition, a portion of the refrigerant line 11 connecting the accumulator 17 and the compressor 10 may be opened.

In addition, a portion of the refrigerant line 11 connecting the second expansion valve 23 to the first expansion valve 15, the evaporator 16, and the accumulator 17 may be closed by the second expansion valve 23.

An operation of the first expansion valve 15 may be stopped. Accordingly, the refrigerant is not supplied to the evaporator 16.

In addition, a portion of the refrigerant line 11 connecting the second end of the third connection line 45 to the second expansion valve 23 may be opened by the second expansion valve 23.

In addition, the first connection line 21 may be opened by the second expansion valve 23.

In an embodiment of the present disclosure, the first line 33 may be closed by the third expansion valve 32. In addition, the second line 34 may be closed.

In addition, the third line 35 may be closed by the fourth expansion valve 41.

In an embodiment of the present disclosure, the second connection line 43 may be opened by the fourth expansion valve 41.

The third connection line 45 may be opened by the third expansion valve 32. In addition, the fourth connection line 47 may be closed by the second expansion valve 23.

In such a state, a partial refrigerant among the refrigerant discharged from the compressor 10 may flow along the second connection line 43 and then be supplied to the fourth expansion valve 41.

The fourth expansion valve 41 may expand the refrigerant introduced from the compressor 10 through the second connection line 43. The fourth expansion valve 41 may flow the expanded refrigerant to a portion of the refrigerant line 11 connected to the third expansion valve 32.

A remaining refrigerant among the refrigerant compressed by the compressor 10 may be supplied to the internal condenser 13 along the opened refrigerant line 11. The refrigerant supplied to the internal condenser 13 may increase the temperature of the ambient air introduced into the HVAC module 12.

Accordingly, the ambient air introduced from the outside may be converted to a high-temperature state while passing through the internal condenser 13 and then introduced into the vehicle interior, thereby implementing heating of the vehicle interior.

In addition, the refrigerant condensed at the internal condenser 13 may be introduced into the third expansion valve 32 along the refrigerant line 11.

The refrigerant having passed through the internal condenser 13 and the refrigerant supplied from the fourth expansion valve 41 may be introduced into the third expansion valve 32, respectively.

The third expansion valve 32 may flow the refrigerant introduced from the internal condenser 13 through the refrigerant line 11, and the refrigerant introduced from the fourth expansion valve 41 through a portion of the refrigerant line 11, together, to the third connection line 45.

The third expansion valve 32 may expand the refrigerant introduced from the internal condenser 13 through the refrigerant line 11.

The third expansion valve 32 may flow the refrigerant introduced from the fourth expansion valve 41 through a portion of the refrigerant line 11, without expansion.

In other words, the third expansion valve 32 may expand the refrigerant condensed at the internal condenser 13 and then flow the expanded refrigerant to the third connection line 45 together with the refrigerant introduced after being expanded at the fourth expansion valve 41.

The refrigerant flowing through the third connection line 45 may be supplied to the second expansion valve 23 along a portion of the refrigerant line 11 connected to the second end of the third connection line 45.

The second expansion valve 23 may flow the refrigerant introduced through the third connection line 45 and a portion of the refrigerant line 11, to the first connection line 21, without expansion. The refrigerant flowing through the first connection line 21 may be supplied to the chiller 20.

The first coolant line 2 and the second coolant line 4 may be closed so that the refrigerant and the coolant may not be heat-exchanged with each other in the chiller 20.

In other words, since the heat generated at the electrical component 3 and the battery module 5 is not sufficient, the coolant may not be introduced into the chiller 20.

The refrigerant having passed through the chiller 20 may introduced into the compressor 10 by passing through the accumulator 17 along the first connection line 21. The introduced refrigerant may be compressed by the compressor 10.

In addition, the refrigerant compressed at the compressor 10 may be supplied to the internal condenser 13 and the fourth expansion valve 41, respectively.

The heat pump system may repeatedly perform the above-described processes.

As such, when the heat source is not sufficient in an early stage of driving the vehicle while the external temperature is low, the heat pump system according to an embodiment of the present disclosure may repeatedly perform the above-described operations to heat the vehicle interior by using the high-temperature refrigerant supplied from the compressor 10.

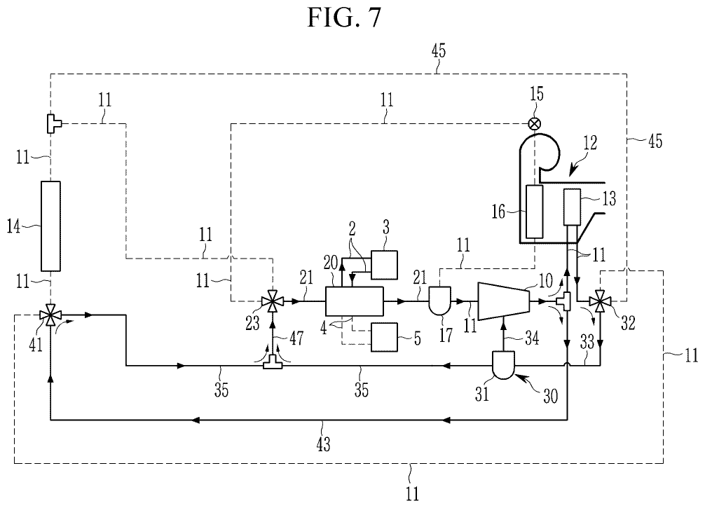

In addition, the second hot gas heating mode for heating the vehicle interior by using the refrigerant without recollecting heat, in which the gas injection device 30 is operated, is described in detail below with reference to FIG. 7.

FIG. 7 is an operation diagram according to a second hot gas heating mode of a heat pump system for a vehicle according to an embodiment of the present disclosure.

Referring to FIG. 7, when the ambient air heat, the waste heat of the electrical component 3, and the waste heat of the battery module 5 are insufficient in terms of generating heat, the heat pump system may not recollect heat.

In other words, when the external temperature is low and heating of the vehicle interior is required while the heat generated by the electrical component 3 and the battery module 5 is not sufficient in an early stage of driving the vehicle, the heat pump system may perform heating of the vehicle interior by directly using the high pressure and high-temperature refrigerant.

As such, heating of the vehicle interior by using only the refrigerant may be referred to as a hot gas heating mode.

In an embodiment of the present disclosure, in the second hot gas heating mode, a portion of the refrigerant line 11 connecting the compressor 10, the internal condenser 13, and the third expansion valve 32 may be opened by the third expansion valve 32.

In addition, a portion of the refrigerant line 11 connecting the third expansion valve 32 to the fourth expansion valve 41, the external heat-exchanger 14, and the second expansion valve 23 may be closed by the second expansion valve 23, the third expansion valve 32, and the fourth expansion valve 41.

In addition, a portion of the refrigerant line 11 connecting the second expansion valve 23 to the first expansion valve 15, the evaporator 16, and the accumulator 17 may be closed by the second expansion valve 23.

The operation of the first expansion valve 15 may be stopped. Accordingly, the refrigerant is not supplied to the evaporator 16.

In addition, a portion of the refrigerant line 11 connecting the accumulator 17 and the compressor 10 may be opened.

In addition, the first connection line 21 may be opened by the second expansion valve 23.

In an embodiment of the present disclosure, the first line 33 may be opened by the third expansion valve 32. In addition, the second line 34 may be opened.

In addition, the third line 35 may be opened by the fourth expansion valve 41.

In an embodiment of the present disclosure, the second connection line 43 may be opened by the fourth expansion valve 41.

The third connection line 45 may be closed by the third expansion valve 32. In addition, the fourth connection line 47 may be opened by the second expansion valve 23.

In such a state, a partial refrigerant among the refrigerant discharged from the compressor 10 may flow along the second connection line 43 and then be supplied to the fourth expansion valve 41.

The fourth expansion valve 41 may expand the refrigerant introduced from the compressor 10 through the second connection line 43. The fourth expansion valve 41 may flow the expanded refrigerant through a partial third line 35 connecting the fourth expansion valve 41 and the second end of the fourth connection line 47.

A remaining refrigerant among the refrigerant compressed by the compressor 10 may be supplied to the internal condenser 13 along the opened refrigerant line 11. The refrigerant supplied to the internal condenser 13 may increase the temperature of the ambient air introduced into the HVAC module 12.

Accordingly, the ambient air introduced from the outside may be converted to a high-temperature state while passing through the internal condenser 13 and then introduced into the vehicle interior, thereby implementing heating of the vehicle interior.

In addition, the refrigerant condensed at the internal condenser 13 may be introduced into the third expansion valve 32 along the refrigerant line 11.

The third expansion valve 32 may expand the refrigerant introduced from the internal condenser 13 through the refrigerant line 11, and may supply the expanded refrigerant to the flash tank 31 through the first line 33.

Accordingly, the expanded refrigerant may be introduced into the flash tank 31. The flash tank 31 may supply the gaseous refrigerant among the interiorly introduced refrigerant to the compressor 10 through the opened second line 34.

In other words, the gas injection device 30 may flow the gaseous refrigerant separated while passing through the flash tank 31 back to the compressor 10 through the second line 34, to increase the flow rate of the refrigerant circulating through the refrigerant line 11.

The liquid refrigerant stored in the flash tank 31 may flow along a portion of the third line 35 connected to the second end of the fourth connection line 47.

Accordingly, the refrigerant flow from the flash tank 31 through a portion of the third line 35, and the refrigerant expanded at the fourth expansion valve 41 and flowing through the remaining portion of the third line 35 may be introduced into the second expansion valve 23 through the fourth connection line 47.

The second expansion valve 23 may flow the refrigerant introduced through the fourth connection line 47, to the first connection line 21, without expansion. The refrigerant flowing through the first connection line 21 may be supplied to the chiller 20.

The first and second coolant lines 4 may be closed so that the refrigerant and the coolant may not be heat-exchanged with each other in the chiller 20.

In other words, since the heat generated at the electrical component 3 and the battery module 5 is not sufficient, the coolant may not be introduced into the chiller 20.

The refrigerant having passed through the chiller 20 may be introduced into the compressor 10 by passing through the accumulator 17 along the first connection line 21. The introduced refrigerant may be compressed by the compressor 10.

In addition, the refrigerant compressed at the compressor 10 may be supplied to the internal condenser 13 and the fourth expansion valve 41, respectively.

The heat pump system may repeatedly perform the above-described processes.

As such, when the heat source is not sufficient in an early stage of driving the vehicle while the external temperature is low, the heat pump system according to an embodiment of the present disclosure may repeatedly perform the above-described operations to heat the vehicle interior by using the high-temperature refrigerant supplied from the compressor 10.

In addition, the gas injection device 30 may increase the flow rate of the refrigerant circulating through the refrigerant line 11, thereby maximizing the heating performance of the system.

Therefore, as described above, according to a heat pump system for a vehicle according to an embodiment of the present disclosure, depending on the air conditioning mode of the vehicle interior, the waste heat of the electrical component 3 and the battery module 5 may be selectively recollected by using a single chiller 20 where the coolant and the refrigerant are heat-exchanged, and the temperature of the battery module 5 may be adjusted.

In addition, the present disclosure may increase the flow rate of the refrigerant introduced into the HVAC module 12 by employing the gas injection device 30 selectively operating in the selected air conditioning mode of the vehicle interior, thereby improving the cooling and heating performance of the system.

In addition, according to the present disclosure, the performance of the system by using the gas injection device 30 may be maximized while minimizing the required system components, and accordingly, streamlining and simplification of the system may be achieved.

In addition, according to the present disclosure, by efficiently adjusting the temperature of the battery module 5, the optimal performance of the battery module 5 may be achieved, and the overall travel distance of the vehicle may be increased through efficient management of the battery module 5.

In addition, when heating the vehicle interior, the present disclosure may selectively use the ambient air heat and the waste heat of the electrical component 3, thereby improving the heating efficiency of the system.

In addition, according to the present disclosure, an opening and/or closing door that was provided inside the conventional HVAC module may be removed, so that the HVAC module may become compact by reducing the number of parts of the HVAC module, thereby reducing manufacturing man-hours and improving productivity.

In addition, according to the present disclosure, through streamlining of an entire system, it is possible to reduce manufacturing cost and weight and improve space utilization of a vehicle and a system for the vehicle.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

### DESCRIPTION OF SYMBOLS

2: first coolant line
3: electrical component
4: second coolant line
5: battery module
10: compressor
11: refrigerant line
12: HVAC module
13: internal condenser
14: external heat-exchanger
15: first expansion valve
16: evaporator
17: accumulator
20: chiller
21: first connection line
23: second expansion valve
30: gas injection device
31: flash tank
32: third expansion valve
33, 34, 35: first, second and third lines
41: fourth expansion valve
43: second connection line
45: third connection line
47: fourth connection line

What is claimed is:

1. A heat pump system for a vehicle, the heat pump system comprising:
a compressor configured to compress a refrigerant;
an HVAC module having an internal condenser and an evaporator connected to the compressor through a refrigerant line;
an external heat-exchanger connected to the internal condenser through the refrigerant line, the external heat-exchanger being configured to condense or evaporate the refrigerant by heat-exchanging with air;
a first expansion valve provided on the refrigerant line between the external heat-exchanger and the evaporator;
an accumulator provided on the refrigerant line between the evaporator and the compressor;
a first connection line having a first end connected to the accumulator;
a chiller provided on the first connection line, the chiller being configured to heat-exchange the refrigerant introduced through the first connection line with a coolant to adjust a temperature of the coolant;
a second expansion valve provided on the refrigerant line between the external heat-exchanger and the first expansion valve, the second expansion valve connected to a second end of the first connection line;
a gas injection device connected to the refrigerant line between the internal condenser and the external heat-exchanger, the gas injection device being configured to selectively expand the refrigerant supplied from the internal condenser or the external heat-exchanger and configured to flow the refrigerant expanded by the gas injection device, the gas injection device being configured to selectively supply a partial refrigerant among the refrigerant supplied from the internal condenser or the external heat-exchanger to the compressor to increase a flow rate of the refrigerant circulating through the refrigerant line; and
a second connection line having a first end connected to the refrigerant line between the compressor and the internal condenser,
wherein a flow direction of the refrigerant is controlled depending on at least one mode of the heat pump system for a temperature control of a vehicle interior.

2. The heat pump system of claim 1, wherein the gas injection device comprises:
a flash tank configured to separate the refrigerant into a gaseous refrigerant and a liquid refrigerant and configured to selectively discharge the gaseous refrigerant and the liquid refrigerant;
a third expansion valve provided on the refrigerant line between the internal condenser and the external heat-exchanger;
a first line having a first end connected to the flash tank and a second end connected to the third expansion valve;
a second line connecting the compressor and the flash tank, the second line configured to selectively supply the gaseous refrigerant from the flash tank to the compressor; and
a third line having a first end connected to the flash tank.

3. The heat pump system of claim 2, wherein the flash tank is configured to be operated when the refrigerant expanded by the third expansion valve is supplied through the first line, and wherein the flash tank is configured to supply the gaseous refrigerant among the refrigerant supplied through the first line to the compressor through the second line, to increase the flow rate of the refrigerant circulating through the refrigerant line.

4. The heat pump system of claim 2, wherein, when an operation of the gas injection device is required, the third expansion valve is configured to expand the refrigerant supplied from the internal condenser or the external heat-exchanger, and configured to supply the refrigerant expanded by the third expansion valve to the flash tank through the first line.

5. The heat pump system of claim 2, further comprising:
a fourth expansion valve provided on the refrigerant line between the third expansion valve and the external heat-exchanger, the fourth expansion valve being connected to a second end of the third line and a second end of the second connection line;
a third connection line having a first end connected to the third expansion valve and a second end connected to the refrigerant line between the external heat-exchanger and the second expansion valve; and
a fourth connection line having a first end connected to the second expansion valve and a second end connected to the third line.

6. The heat pump system of claim 5, wherein the second expansion valve, the third expansion valve, and the fourth expansion valve are 4-way expansion valves configured to be selectively operated in the at least one mode, and configured to selectively expand the refrigerant while controlling the flow direction of the refrigerant supplied thereto.

7. The heat pump system of claim 5, wherein the at least one mode comprises:
a first cooling mode for cooling the vehicle interior, without operating the gas injection device;
a second cooling mode for cooling the vehicle interior, by operating the gas injection device;
a first heating mode for heating the vehicle interior, without operating the gas injection device; and
a second heating mode for heating the vehicle interior, by operating the gas injection device;
a first hot gas heating mode for heating the vehicle interior by using the refrigerant without recollecting heat and without operating the gas injection device; and
a second hot gas heating mode for heating the vehicle interior by using the refrigerant without recollecting heat, by operating the gas injection device.

8. The heat pump system of claim 7, wherein, in the first cooling mode:
a portion of the refrigerant line connecting the first end of the second connection line to the internal condenser, the third expansion valve, and the fourth expansion valve is configured to be closed by the third expansion valve and the fourth expansion valve;
a portion of the refrigerant line connecting the fourth expansion valve to the external heat-exchanger and the second expansion valve is configured to be opened by the second expansion valve;
a portion of the refrigerant line connecting the second expansion valve to the first expansion valve, the evaporator, the accumulator, and the compressor is configured to be opened by the first expansion valve;
the first line is configured to be closed by the third expansion valve;
the second line is configured to be closed;
the third line is configured to be closed by the fourth expansion valve;
the second connection line is configured to be opened by the fourth expansion valve, such that the refrigerant discharged from the compressor is configured to flow to the second connection line;
the third connection line is configured to be closed by the third expansion valve;
the fourth connection line is configured to be closed by the second expansion valve;
the first expansion valve is configured to expand the refrigerant introduced through the refrigerant line, and configured to supply the refrigerant expanded by the first expansion valve to the evaporator;
the second expansion valve is configured to flow the refrigerant introduced from the external heat-exchanger through the refrigerant line, to the refrigerant line connected to the first expansion valve, without expansion;
an operation of the third expansion valve is configured to be stopped; and
the fourth expansion valve is configured to supply the refrigerant introduced through the second connection line, to the external heat-exchanger, without expansion.

9. The heat pump system of claim 7, wherein, in the second cooling mode:
a portion of the refrigerant line connecting the first end of the second connection line to the internal condenser, the third expansion valve, and the fourth expansion valve is configured to be closed by the third expansion valve and the fourth expansion valve;
a portion of the refrigerant line connecting the fourth expansion valve to the external heat-exchanger and the second end of the third connection line is configured to be opened by the fourth expansion valve;
a portion of the refrigerant line connecting the second end of the third connection line to the second expansion valve is configured to be closed;
a portion of the refrigerant line connecting the second expansion valve to the first expansion valve, the evaporator, the accumulator, and the compressor is configured to be opened by the first expansion valve;
the first line is configured to be opened by the third expansion valve;
the second line is configured to be opened;
a portion of the third line connecting the flash tank and a second end of the fourth connection line is configured to be opened;
a remaining portion of the third line connecting the second end of the fourth connection line to the fourth expansion valve is configured to be closed;
the second connection line is configured to be opened by the fourth expansion valve, such that the refrigerant discharged from the compressor is configured to flow to the second connection line;
the third connection line is configured to be opened by the third expansion valve;
the fourth connection line is configured to be opened by the second expansion valve;
the first expansion valve is configured to expand the refrigerant introduced through the refrigerant line, and configured to supply the refrigerant expanded by the first expansion valve to the evaporator;
the second expansion valve is configured to flow the refrigerant introduced through the fourth connection line, to the refrigerant line connected to the first expansion valve, without expansion;
the third expansion valve is configured to expand the refrigerant introduced through a portion of the refrigerant line and the third connection line from the external heat-exchanger, and configured to flow the refrigerant expanded by the third expansion valve to the first line;
the fourth expansion valve is configured to supply the refrigerant introduced through the second connection line, to the external heat-exchanger, without expansion; and
the flash tank is configured to supply the gaseous refrigerant among the refrigerant to the compressor through the opened second line.

10. The heat pump system of claim 7, wherein, when cooling of a battery module is required in the first cooling mode and the second cooling mode:
the first connection line is configured to be opened by the second expansion valve;
the second expansion valve is configured to expand a partial refrigerant among the refrigerant introduced from the external heat-exchanger so that the refrigerant expanded by the second expansion valve is introduced into the chiller, and the second expansion valve is configured to flow the refrigerant expanded by the second expansion valve to the first connection line.

11. The heat pump system of claim 7, wherein, in the first heating mode:
a portion of the refrigerant line connecting the compressor, the internal condenser, the third expansion valve, the fourth expansion valve, the external heat-exchanger, and the second expansion valve is configured to be opened by the second expansion valve, the third expansion valve, and the fourth expansion valve;
a portion of the refrigerant line connecting the accumulator and the compressor is configured to be opened;
the first connection line is configured to be opened by the second expansion valve;
the first line is configured to be closed by the third expansion valve;
the second line is configured to be closed;
the third line is configured to be closed by the fourth expansion valve;
the second connection line is configured to be closed by the fourth expansion valve;
the third connection line is configured to be closed by the third expansion valve;
the fourth connection line is configured to be closed by the second expansion valve;
the second expansion valve is configured to expand the refrigerant supplied from the external heat-exchanger, and configured to supply the refrigerant expanded by the second expansion valve to the chiller through the first connection line;
the third expansion valve is configured to expand the refrigerant introduced from the internal condenser through the refrigerant line, and configured to supply the refrigerant expanded by the third expansion valve to the fourth expansion valve; and
the fourth expansion valve is configured to supply the refrigerant introduced through a portion of the refrigerant line, to the external heat-exchanger, without expansion.

12. The heat pump system of claim 7, wherein, in the second heating mode:
a portion of the refrigerant line connecting the compressor, the internal condenser, and the third expansion valve is configured to be opened by the third expansion valve;
a portion of the refrigerant line connecting the third expansion valve to the fourth expansion valve is configured to be closed by the third expansion valve and the fourth expansion valve;
a portion of the refrigerant line connecting the accumulator and the compressor is configured to be opened;
the first connection line is configured to be opened by the second expansion valve;
the first line is configured to be opened by the third expansion valve;
the second line is configured to be opened;
the third line is configured to be opened by the fourth expansion valve;
the second connection line is configured to be closed by the fourth expansion valve;
the third connection line is configured to be closed by the third expansion valve;
the fourth connection line is configured to be closed by the second expansion valve;
the second expansion valve is configured to expand the refrigerant supplied from the external heat-exchanger, and configured to supply the refrigerant expanded by the second expansion valve to the chiller through the first connection line;
the third expansion valve is configured to expand the refrigerant introduced from the internal condenser through the refrigerant line, and configured to flow the refrigerant expanded by the third expansion valve to the first line;
the fourth expansion valve is configured to expand the refrigerant introduced through the third line, and configured to supply the refrigerant expanded by the fourth expansion valve to the external heat-exchanger; and
the flash tank is configured to supply the gaseous refrigerant among the refrigerant to the compressor through the opened second line.

13. The heat pump system of claim 7, wherein, when dehumidification is required in the first heating mode and the second heating mode:
a portion of the refrigerant line connecting the second expansion valve to the first expansion valve, the evaporator, and the accumulator is configured to be opened by the second expansion valve;
the first expansion valve is configured to expand the refrigerant introduced through the refrigerant line, and configured to supply the refrigerant expanded by the first expansion valve to the evaporator; and
the second expansion valve is configured to flow a partial refrigerant among the refrigerant supplied from the external heat-exchanger, to the refrigerant line connected to the first expansion valve, without expansion.

14. The heat pump system of claim 7, wherein, in the first hot gas heating mode:
a portion of the refrigerant line connecting the compressor, the internal condenser, the third expansion valve, and the fourth expansion valve is configured to be opened by the third expansion valve and the fourth expansion valve;
a portion of the refrigerant line connecting the accumulator and the compressor is configured to be opened;
a portion of the refrigerant line connecting the second expansion valve to the first expansion valve, the evaporator, and the accumulator is configured to be closed by the second expansion valve;
a portion of the refrigerant line connecting a second end of the third connection line to the second expansion valve is configured to be opened by the second expansion valve;
the first connection line is configured to be opened by the second expansion valve;
the first line is configured to be closed by the third expansion valve;
the second line is configured to be closed;
the third line is configured to be closed by the fourth expansion valve;
the second connection line is configured to be opened by the fourth expansion valve;
the third connection line is configured to be opened by the third expansion valve;
the fourth connection line is configured to be closed by the second expansion valve;
an operation of the first expansion valve is configured to be stopped;
the second expansion valve is configured to flow the refrigerant introduced through the third connection line and a portion of the refrigerant line, to the first connection line, without expansion;
the third expansion valve is configured to flow the refrigerant introduced from the internal condenser through the refrigerant line, and the refrigerant introduced from the fourth expansion valve through a portion of the refrigerant line, together to the third connection line; and
the fourth expansion valve is configured to expand the refrigerant introduced from the compressor through the second connection line and configured to flow the refrigerant expanded by the fourth expansion valve to a portion of the refrigerant line connected to the third expansion valve.

15. The heat pump system of claim 14, wherein the third expansion valve is configured to:
expand the refrigerant introduced from the internal condenser through the refrigerant line; and
flow the refrigerant introduced from the fourth expansion valve through a portion of the refrigerant line, without expansion.

16. The heat pump system of claim 7, wherein, in the second hot gas heating mode:
a portion of the refrigerant line connecting the compressor, the internal condenser, and the third expansion valve is configured to be opened by the third expansion valve;
a portion of the refrigerant line connecting the third expansion valve to the fourth expansion valve, the external heat-exchanger, and the second expansion valve is configured to be closed by the second expansion valve, the third expansion valve, and the fourth expansion valve;
a portion of the refrigerant line connecting the second expansion valve to the first expansion valve, the evaporator, and the accumulator is configured to be closed by the second expansion valve;
a portion of the refrigerant line connecting the accumulator and the compressor is configured to be opened;
the first connection line is configured to be opened by the second expansion valve;
the first line is configured to be opened by the third expansion valve;
the second line is configured to be opened;
the third line is configured to be opened by the fourth expansion valve;
the second connection line is configured to be opened by the fourth expansion valve;
the third connection line is configured to be closed by the third expansion valve;
the fourth connection line is configured to be opened by the second expansion valve;
an operation of the first expansion valve is configured to be stopped;
the second expansion valve is configured to flow the refrigerant introduced through the fourth connection line, to the first connection line, without expansion;
the third expansion valve is configured to expand the refrigerant introduced from the internal condenser through the refrigerant line, and configured to flow the refrigerant expanded by the third expansion valve to the first line;
the flash tank is configured to supply the gaseous refrigerant among the refrigerant to the compressor through the opened second line, and configured to flow the liquid refrigerant to a portion of the third line; and
the fourth expansion valve is configured to expand the refrigerant introduced from the compressor through the second connection line, and configured to flow the refrigerant expanded by the fourth expansion valve to a remaining portion of the third line connecting the fourth expansion valve and a second end of the fourth connection line.

17. The heat pump system of claim 1, further comprising an electrical component and a battery module through which the coolant circulates,
wherein the chiller is connected to the electrical component through a first coolant line through which the coolant circulates, and connected to the battery module through a second coolant line through which the coolant circulates.

18. The heat pump system of claim 17, wherein, when a waste heat of the electrical component is to be recollected, the first coolant line is configured to be opened to connect the chiller and the electrical component.

19. The heat pump system of claim 17, wherein, when the battery module is to be cooled, or when a waste heat of the battery module is to be recollected, the second coolant line is configured to be opened to connect the chiller and the battery module.
